(19) United States
(12) Patent Application Publication
(10) Pub. No.: US 2026/0079792 A1
(43) Pub. Date: Mar. 19, 2026

(54) DISK DEVICE

(71) Applicants: Kabushiki Kaisha Toshiba, Tokyo (JP); Toshiba Electronic Devices & Storage Corporation, Tokyo (JP)

(72) Inventor: Shoichi SHIMIZU, Yokohama Kanagawa (JP)

(21) Appl. No.: 19/261,364

(22) Filed: Jul. 7, 2025

(30) Foreign Application Priority Data
Sep. 19, 2024 (JP) 2024-162016

(51) Int. Cl. G06F 11/10

(52) U.S. Cl. CPC G06F 11/1068; G06F 11/1016; G06F 11/1048

(57) ABSTRACT

According to one embodiment, a disk device includes a non-volatile memory and a controller for accessing the non-volatile memory. The non-volatile memory includes an error correction circuit and a storage area. The storage area includes first, second, and third areas. The first area comprises a plurality of error correction units. The controller stores information from a first error correction unit to the second area when the first error correction unit includes a bit that is a correctable error for the error correction processing by the error correction circuit, then creates or updates address substitution information in which an address of the first error correction unit is associated with an address at which the information from the first error correction unit was stored in the second area and then stores the address substitution information in the third area.

### CROSS-REFERENCE TO RELATED APPLICATION(S)

This application is based upon and claims the benefit of priority from Japanese Patent Application No. 2024-162016, filed Sep. 19, 2024, the entire contents of which are incorporated herein by reference.

### FIELD

Embodiments described herein relate generally to a disk device.

### BACKGROUND

In a disk device having a non-volatile memory and a controller, information used by the controller may be stored in the non-volatile memory in a non-volatile manner. In the disk device, it is desirable to appropriately manage information stored in the non-volatile memory.

### BRIEF DESCRIPTION OF THE DRAWINGS

FIG. 1 is a diagram showing a configuration of a disk device according to an embodiment.

FIG. 2 is a diagram showing a configuration of a non-volatile memory in an embodiment.

FIG. 3 is a diagram showing a configuration of a memory cell array in an embodiment.

FIG. 4 is a diagram depicting aspects related to generation of address substitution information in an embodiment.

FIG. 5 is a diagram depicting aspects related to updating of address substitution information in an embodiment.

FIG. 6 is a flowchart of an inspection process in an embodiment.

FIG. 7 is a flowchart of an startup process in an embodiment.

FIG. 8 is a flowchart of an inspection processing in a modification of an embodiment.

FIG. 9 is a diagram depicting aspects related to updating of address substitution information in a modification of an embodiment.

FIG. 10 is a flowchart of a startup process in a modification of an embodiment.

### DETAILED DESCRIPTION

According to one embodiment, a disk device includes a non-volatile memory and a controller for accessing the non-volatile memory. The non-volatile memory includes an error correction circuit and a storage area. The storage area includes first, second, and third areas. The first area comprises a plurality of error correction units (correction unit sized sub-areas). The controller stores information from a first error correction unit to the second area when the first error correction unit includes a bit that that is a correctable error for the error correction processing by the error correction circuit, then creates or updates address substitution information in which an address of the first error correction unit is associated with an address at which the information from the first error correction unit was stored in the second area, and then stores the address substitution information in the third area.

Hereinafter, a disk device according to certain example embodiments will be described with reference to the accompanying drawings. However, the present disclosure is not limited to these specific example embodiments.

### Embodiment

The disk device according to the embodiment includes a non-volatile memory and a controller, and information used by the controller is stored in the non-volatile memory in a non-volatile manner. However, the disk device is designed to appropriately manage the information stored in non-volatile memory.

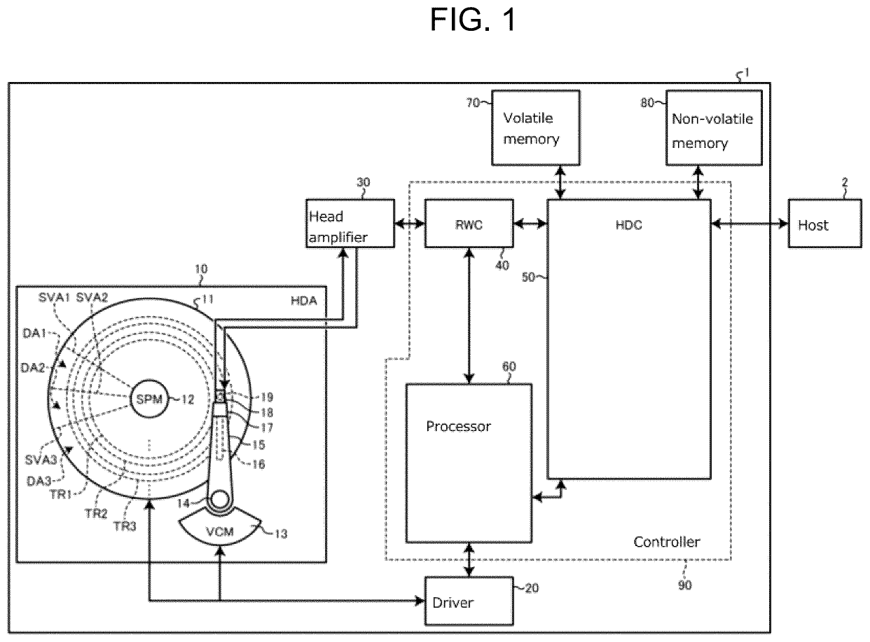

The disk device 1 may be configured as shown in FIG. 1. FIG. 1 is a diagram showing the configuration of the disk device 1.

The disk device 1 is connected to the host 2 via a communication medium and functions as external storage for the host 2.

The disk device 1 is a disk-type storage medium such as a hard disk drive (HDD) or a magneto-optical disk drive. The communication medium may be a serial communication line. The host 2 is, for example, an information terminal such as a computer.

The disk device 1 transmits data read from the disk medium 11 to the host 2 based on a read command or the like received from the host 2, and writes data to the disk medium 11 based on a write command and data received from the host 2.

The disk device 1 includes a head disk assembly (HDA) 10, a driver 20, a head amplifier 30, a volatile memory 70, a non-volatile memory 80, and a controller 90.

The controller 90 centrally controls each unit of the disk device 1. The controller 90 may be configured as a one chip integrated circuit (System on Chip). The controller 90 includes a read/write channel (RWC) 40, a hard disk controller (HDC) 50, and a processor 60.

The HDA10 is stored in a housing or the like. The HDA10 includes disk media 11, a spindle motor (SPM) 12, a voice coil motor (VCM) 13, a pivot 14, an arm 15, and a head 19.

Although FIG. 1 shows an example in which one disk 11 and one head 19 are provided in the HDA10, one or more disk 11 and one or more head 19 may be provided.

The disk medium 11 is a disc-shaped recording medium, and may be a magnetic disk or a magneto-optical disk. The disk media 11 is attached to a SPM12 and rotated by the driving of the SPM12. The SPM12 is installed in a housing or the like of the disk device 1.

A plurality of tracks TR are set on the disk medium 11. The plurality of tracks TR are arranged concentrically. In FIG. 1, three tracks TR are illustrated as representative.

Each track TR may include a plurality of servo areas SA and data areas DA alternately arranged. In FIG. 1, a servo-area SA1, a data-area DA1, a servo-area SA2, a data-area DA2, a servo-area SA3, and a data-area DA3 are illustrated.

Servo information is written in each servo area SA. Data is written to each data area DA.

The VCM 13 is an actuator that rotates arm 15 around the pivot 14 based on a current or voltage input from driver 20.

The pivot 14 is a bearing for supporting the arm 15 and the like and rotating the arm 15 and the like.

The arm 15 supports the head 19 via the slider 18. The arm 15 transmits power from the VCM13 to the head 19, and drives the head 19 in the radial direction of the disk 11.

A microactuator (MA) 17 is connected to a suspension 16.

The microactuator (MA) 17 performs position adjustment such as tracking control of the head 19 based on the input current or voltage.

A head 19 is mounted on the slider 18.

The head 19 writes data to the disk medium 11 and reads data recorded on a data track of the disk medium 11.

The head 19 includes a write element 19W for writing data to the disk 11 and a read element 19R for reading data recorded on a data track of the disk medium 11.

The driver 20 outputs a current or a voltage for driving and controlling SPM12, VCM13, MA17, and the like under the control of the controller 90.

The head amplifier 30 includes a read amplifier and a write driver. The read amplifier amplifies a read signal read from the disk 11 and outputs the amplified read signal to the RWC40. The write driver outputs a write current corresponding to a signal output from the RWC40 to the head 19.

The RWC40 controls the head amplifier 30 to read data from the disk media 11 or write data to the disk media 11 in response to an instruction from the HDC50, the processor 60, or the like.

The RWC40 receives a read signal from the head amplifier 30 and extracts the read data, or generates a write signal based on a write data commanded to write and outputs the write signal to the head amplifier 30.

The RWC40 also has a function of measuring the signal qualities of the read data received from the head amplifier 30. The R/W channel 40 may extract the position information of the head 19 based on the servo information received from the head amplifier 30.

The HDC50 is an interface between the disk device 1 and the host 2. The HDC50 may be configured by an IC chip, a system LSI, an FPGA, or the like including a processing device (e.g., a processor) having arithmetic functions such as CPUS, other computing functions, various memories, and the like.

Various processes of the HDC50 may be executed by a software program (including firmware) or may be provided as hardware or a combination of software and hardware.

The HDC50 receives commands such as a command to write data to the disk media 11 and a command to read data from the disk media 11 from the host 2, for example. The HDC50 controls each unit of the disk device 1 and transfers data between the host 2 and the RWC40 based on the received command. The HDC50 may control writing of data to the volatile memory 70 and the non-volatile memory 80, and the like.

The processor 60 controls each unit of the disk device 1. The processor 60 may be configured by an IC chip, a system LSI, an FPGA, or the like including a CPU, other computing functions, various memories, and the like.

The processor 60 performs overall control of the disk device 1 in accordance with firmware stored in advance in the non-volatile memory 80 and/or the disk medium 11. The firmware includes initial (startup) firmware and control firmware used for normal operation.

The initial firmware that is executed first at startup is stored in the non-volatile memory 80.

The control firmware used for the normal operation is recorded in the disk medium 11, read from the disk medium 11 by the control according to the initial firmware, and temporarily stored in the volatile memory 70.

The volatile memory 70 temporarily stores information necessary for processing in the disk device 1. The volatile memory 70 is, for example, a dynamic random access memory (DRAM) or a synchronous dynamic random access memory (SDRAM).

The non-volatile memory 80 is a semiconductor memory that records information in a non-volatile manner. The non-volatile memory 80 may include a flash memory. The flash memory may include a serial NAND flash memory.

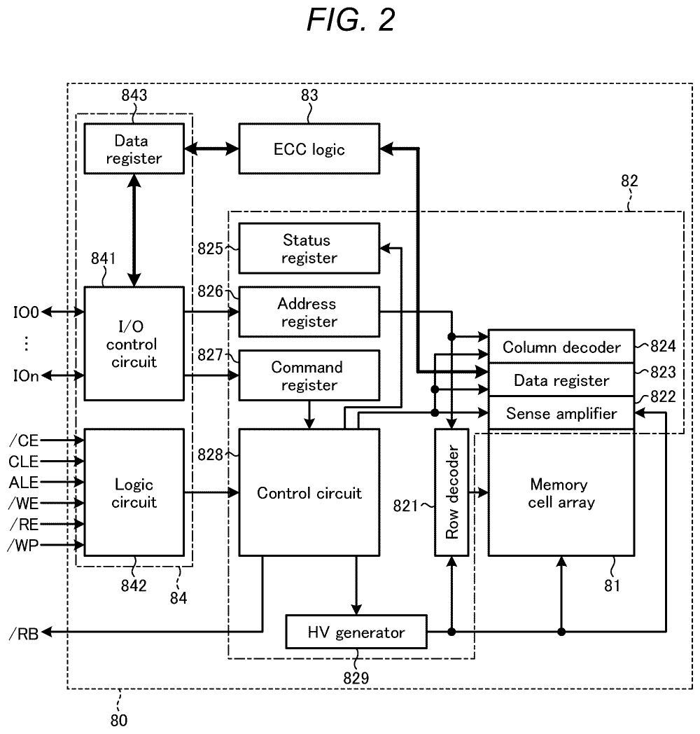

The nonvolatile memory 80 may be configured as shown in FIG. 2. FIG. 2 is a diagram showing the configuration of the non-volatile memory 80.

The non-volatile memory 80 includes a memory cell array 81, a peripheral circuit 82, an error correction circuit 83, and an input-output interface 84.

The peripheral circuit 82 includes a row decoder 821, a sense amplifier 822, a data register 823, a column decoder 824, a status register 825, an address register 826, a command register 827, a control circuit 828, and a voltage generation circuit 829.

The input-output interface 84 includes an input-output control circuit 841, a logic circuit 842, and a data register 843.

The memory cell array 81 includes a plurality of non-volatile memory cells associated with rows and columns. The memory cells in the same row are connected to the same word line, and the memory cells in the same column are connected to the same bit line.

Data read and write are performed all at once for a plurality of memory cells connected to the same word line. A unit of data read and write is called a page.

The plurality of memory cells connected to the same word line correspond to one or more pages. When each memory cell can store n bits, a plurality of memory cells connected to the same word line correspond to n pages. The data of one page includes net data and management data. The net data is managed in units called sectors.

For example, one page includes four sectors, and each sector has a data size of 512 bytes. The management data includes, for example, ECC data (parity) for error correction.

Error correction can be performed for each sector. Therefore, the management data includes ECC data prepared for each sector.

Data is erased all at once in units of multiple pages. A unit of data erase may be called a block.

The row decoder 821 decodes a row direction of the memory cell array 81 and a page address designating of the page. Then, a word line and a page are selected according to the decoding result, and a voltage required for data write, read, and erase is applied.

When data is read, the sense amplifier 822 senses data read from the memory cell array 81 and transfers the data to the data register 823. When data is written, the data in the data register 823 is transferred to the memory cell array 81.

The data register 823 temporarily holds write data or read data for one page.

The column decoder 824 decodes a column address designating the column direction of the memory cell array 81. Then, in accordance with the decoding result, the data is transferred to the data register 823 at the time of writing, and the data is read from the data register 823 at the time of reading.

The error correction circuit 83 performs error correction processing. The error correction processing includes error correction encoding processing and error correction decoding processing. The error correction processing is also referred to as error correction code (ECC) processing.

When data is written, the error correction circuit 83 performs an error correction encoding process. The error correction circuit 83 generates parity for each sector based on data received from the controller 90 via the input-output interface 84, and transfers a set of the parity and the net data to the data register 823 as a code word.

When data is read, the error correction circuit 83 performs error correction decoding processing. The error correction circuit 83 generates a syndrome for each sector of data included in the code word based on the parity included in the code word transferred from the data register 823, and detects the presence or absence of an error.

When an error is detected, the error correction circuit 83 checks whether the number of error bits exceeds the number of correctable error bits. The number of error bits that can be corrected per sector is, for example, 8 bits.

The error correction circuit 83 also can output the number of error bits detected in each sector to the status register 825 as status information.

If the number of error bits is equal to or less than the number of correctable error bits, the error correction circuit 83 determines that the error is a correctable error, specifies the bit position, and corrects the error. The error correction circuit 83 supplies the corrected data to the data register 843, and supplies a correctable error notification signal to the controller 90 via the data register 843 and the input-output control circuit 841.

If the number of error bits exceeds the number of correctable error bits, the error correction circuit 83 determines that an uncorrectable error has occurred and supplies an uncorrectable error notification signal to the controller 90 via the data register 843 and the input-output control circuit 841.

The logic circuit 842 receives various signals such as /CE, CLE, ALE, /WE, /RE, and /WP from the controller 90.

The input-output control circuit 841 receives the signal IO (as IO0 to IOn). When the signal IO represents an address (when ALE=“H”), the input-output control circuit 841 causes the address register 826 to hold the received address.

When the signal IO represents a command (CLE=“H”), the received command is held in the command register 827. Further, when the signal IO represents data (ALE=CLE=“L”), the data is held in the data register 843.

If the correctable error notification signal is held in the data register 843, the input-output control circuit 841 transmits the correctable error notification signal to the controller 90.

The status register 825 holds various kinds of status information of the non-volatile memory 80. The status information includes the number of error bits supplied from the error correction circuit 83, information indicating whether the write operation and the erase operation supplied from the control circuit 828 have succeeded (passed) or failed, and the like.

The control circuit 828 controls the entire non-volatile memory 80 based on the command held in the command register 827 and various signals input to the logic circuit 842. The control circuit 828 generates a ready/busy signal /RB and outputs the ready/busy signal /RB to the controller 90.

The voltage generation circuit 829 generates a voltage necessary for data write, read, and erase operations based on a command from the control circuit 828, and supplies the voltage to the memory cell array 81, the row decoder 821, and the sense amplifier 822.

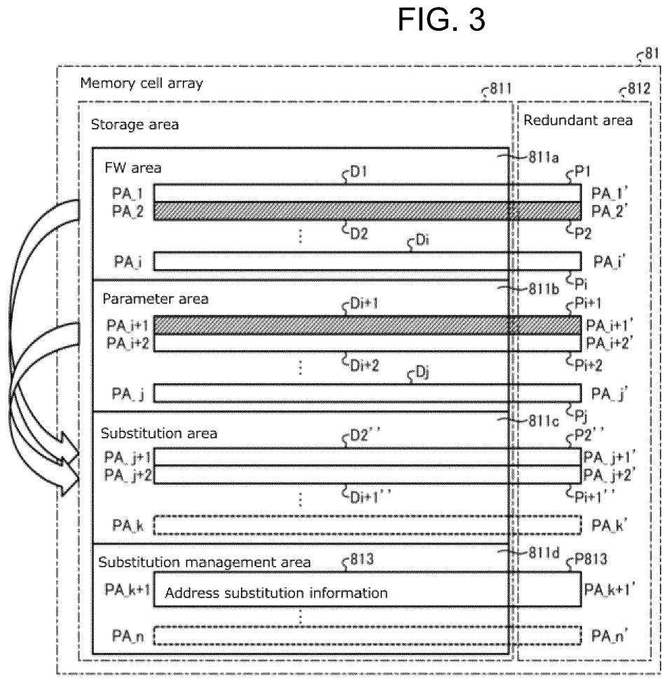

As shown in FIG. 3, the memory cell array 81 includes a storage area 811 and a redundant area 812. FIG. 3 is a diagram showing the configuration of the memory cell array 81, and a horizontally long rectangle indicates one error correction unit. In the following, a case where the unit of error correction by the error correction circuit 83 is a page will be exemplified, but the unit of error correction may be a memory cell group in which a plurality of pages are collected for each word line, or may be a block in which a plurality of pages are collected for a plurality of word lines as a unit of collective erasing all at once.

The storage area 811 is an area in which information can be stored by the controller 90, and the redundant area 812 is an area used for error correction. The storage area 811 may store management information by the controller 90. The management information includes management information related to the startup process of the disk device 1.

The storage area 811 includes a FW area 811a and a parameter area 811b. The FW area 811a and the parameter area 811b may be managed by the controller 90 by being assigned physical addresses. The physical address may include a block address, a page address, and an offset within a page.

FIG. 3 illustrates a case where physical addresses PA_1 to PA_i are assigned to the FW area 811a and physical addresses PA_i+1 to PA_j are assigned to the parameter area 811b. The value “i” is an arbitrary integer of 3 or more. The value “j” is an arbitrary integer greater than i by 3 or more.

The FW area 811a stores firmware of the disk device 1. The firmware may be initial firmware that is executed first when the disk device 1 is started up. The parameter area 811b stores parameters of the disk device 1. The parameter may be a startup parameter applied to the initial firmware at the time of startup of the disk device 1.

For example, in the disk device 1, when the controller 90 cannot read the initial firmware from the non-volatile memory 80 or cannot read the startup parameters from the non-volatile memory 80, the disk device 1 cannot be started up normally, and the failure analysis is also difficult.

In response to this, the controller 90 performs an error correction process as a read check of the FW area 811a and the parameter area 811b at a predetermined inspection time and when a correctable error occurs before any uncorrectable error occurs in the error correction process, the controller 90 treats the area as prohibited from use, allocates an address to another area in which a correctable error has not been registered, and stores the error-corrected data. As a result, it is possible to reduce read errors of FW/parameters and the like, and it is possible to expect that a startup failure of the disk device 1 will be avoided.

That is, the storage area 811 further includes a substitution area 811c and a substitution management area 811d. The substitution area 811c and the substitution management area 811d may be managed by the controller 90 by being assigned physical addresses.

FIG. 3 illustrates a case where physical addresses PA_j+1 to PA_k are assigned to the substitution area 811c, and physical addresses PA_k+1 to PA_n are assigned to the substitution management area 811d. The value “k” is an arbitrary integer greater than j by 3 or more. The value “n” is an arbitrary integer greater than k by 2 or more.

When data is written, the data register 823 stores the data in the storage area 811 and the parity in the redundant area 812, among the data and the parity generated and stored by the error correction circuit 83, in response to a write command from the controller 90. At this time, the physical address of the data in the storage area 811 and the physical address of the parity in the redundant area 812 are associated with each other (for example, by being set to the same page address).

For example, when a code word including a data D1 and a parity P1 thereof, which are a part of the firmware, is stored in the data register 823, the sense amplifier 822 stores the data D1 in the physical address PA_1 of the FW area 811a, and stores the parity P1 in the physical address PA_1′ of the redundant area 812. The physical address PA_1 and the physical address PA_1′ are associated with each other (for example, by being set as the same page address).

When a code word including a data D2 and a parity P2 thereof, which are another part of the firmware, is stored in the data register 823, the sense amplifier 822 stores the data D2 in the physical address PA_2 of the FW area 811a, and stores the parity P2 in the physical address PA_2′ of the redundant area 812. The physical address PA_2 and the physical address PA_2′ are associated with each other (for example, by being set as the same page address).

When a code word including the data Di and the parity Pi thereof, which is another part of the firmware, is stored in the data register 823, the sense amplifier 822 stores the data Di in the physical address PA_i of the FW area 811a and stores the parity Pi in the physical address PA_i′ of the redundant area 812. n is an arbitrary integer of 3 or more. The physical address PA_i and the physical address PA_i′ are associated with each other (for example, by being set as the same page address).

When a code word including a data Di+1 and its parity Pi+1, which are a part of the parameters, is stored in the data register 823, the sense amplifier 822 stores the data Di+1 in the physical address PA_i+1 of the parameter area 811b and stores the parity Pi+1 in the physical address PA_i+1′ of the redundant area 812. Here, i is an arbitrary integer of w or more. The physical address PA_i+1 and the physical address PA_i+1′ are associated with each other (for example, by being set as the same page address).

When a code word including a data Di+2 and its parity Pi+2, which are a part of the parameters, is stored in the data register 823, the sense amplifier 822 stores the data Di+2 in the physical address PA_i+2 of the parameter area 811b and stores the parity Pi+2 in the physical address PA_i+2′ of the redundant area 812. The physical address PA_i+2 and the physical address PA_i+2′ are associated with each other (for example, by being set as the same page address).

When a code word including the data Dj and the parity Pj thereof, which are a part of the parameters, is stored in the data register 823, the sense amplifier 822 stores the data Dj in the physical address PA_j of the parameter area 811b and stores the parity Pj in the physical address PA_j′ of the redundant area 812. The physical address PA_j and the physical address PA_j′ are associated with each other (for example, by being set as the same page address).

When a correctable error occurs in data in the FW area 811a and/or the parameter area 811b, the substitution area 811c stores the error-corrected data as a substitute for the data. In response to this, the address substitution information 813 is stored in the substitution management area 811d. The address substitution information 813 is information for managing that the error-corrected data as a substitution of the data in the FW area 811a and/or the parameter area 811b is stored in the substitution area 811c.

FIG. 3 illustrates a case where a correctable error has occurred in data D2 in the FW area 811a. The error correction circuit 83 corrects the error of the data D2 by using the parity P2, and generates “a parity P2 for” the data D2 after the correction. The error correction circuit 83 transfers the code word including the data D2 “and the parity P2” to the data register 823, and supplies a correctable error notification signal to the controller 90 via the data register 843 and the input-output control circuit 841.

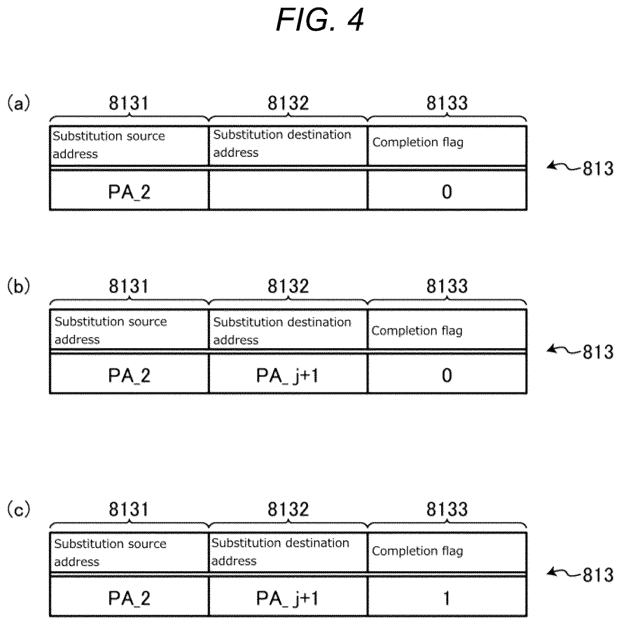

At this time, the controller 90 may instruct the non-volatile memory 80 to generate the address substitution information 813 and store the address substitution information 811 in the substitution management area 811d. For example, the controller 90 may generate address substitution information 813 as shown in FIG. 4 on the volatile memory 70. FIG. 4 is a diagram showing the structure and generation of the address substitution information 813.

In the address substitution information 813, a physical address of a substitution source, a physical address of a substitution destination, and a completion flag are associated with one or more physical addresses of substitution sources. The address substitution information 813 may be implemented in the form of a table. The address substitution information 813 includes substitution source address field 8131, a substitution destination address field 8132, and a completion flag field 8133. The physical address of the data of the substitution source is recorded in the substitution source address field 8131. The substitution destination address field 8132 records the physical address of the substitution destination data. The completion flag field 8133 indicates whether or not the substitution has been completed. In the completion flag field 8133, a “0” indicating incompletion or “1” indicating completion may be recorded.

When the correctable error notification signal of the date D2 of the FW area 811a is received, the controller 90 records the physical address PA_1 of the date D2 in the substitution source address field 8131 and records “0” in the corresponding completion flag field 8133 as shown in FIG. 4, part (a). In response to the correctable error notification signal, the controller 90 instructs the non-volatile memory 80 to store the date D2″ in the substitution area 811c. In response to this instruction, the control circuit 828 determines the physical address PA_j+1 of the substitution area 811c as the storage destination of the data D2″ in the data register 823. The control circuit 828 transfers the physical address PA_j+1 to the data register 823. The error correction circuit 83 notifies the controller 90 of the physical address PA_j+1 via the data register 843 and the input-output control circuit 841.

When the controller 90 receives the physical address PA_j+1, the controller 90 records the physical address PA_j+1 of the data D2 in the substitution destination address field 8132 corresponding to the substitution source address “PA_1” as shown in FIG. 4, part (b).

In the non-volatile memory 80, the sense amplifier 822 receives the notification of the physical address PA_j+1 from the control circuit 828. In response to this, the sense amplifier 822 stores the data D2″ in the data register 823 in the physical address PA_j+1 of the substitution area 811c, and stores the parity P2″ in the data register 823 in the physical address PA_j+1′ of the redundant area 812. The physical address PA_j+1 and the physical address PA_j+1′ are associated with each other (for example, by being set as the same page address). The sense amplifier 822 transfers the substitution completion notification signal to the data register 823. The error correction circuit 83 supplies the substitution completion notification signal to the controller 90 via the data register 843 and the input-output control circuit 841.

When the controller 90 receives the substitution completion notification signal, as illustrated in FIG. 4, part (c), the controller 90 records 1 in the completion flag field 8133 corresponding to the substitution source address “PA_1” and the substitution destination address “PA_j+1”.

Thus, the data D2 of the FW area 811a can be substituted with the data D2″ of the substitution area 811c. The control circuit 828 can access the data D2″ of the physical address PA_j+1 instead of the data D2 of the physical address PA_1 by referring to the address substitution information 813.

In FIG. 3, a case where a correctable error occurs in data Di+1 in the parameter area 811b is illustrated. The error correction circuit 83 corrects the error of the data Di+1 using the parity Pi+1 and generates a parity Pi+1″ for the corrected data Di+1″. The error correction circuit 83 transfers the code word including the data Di+1″ and the parity Pi+1″ to the data register 823, and supplies a correctable error notification signal to the controller 90 via the data register 843 and the input-output control circuit 841.

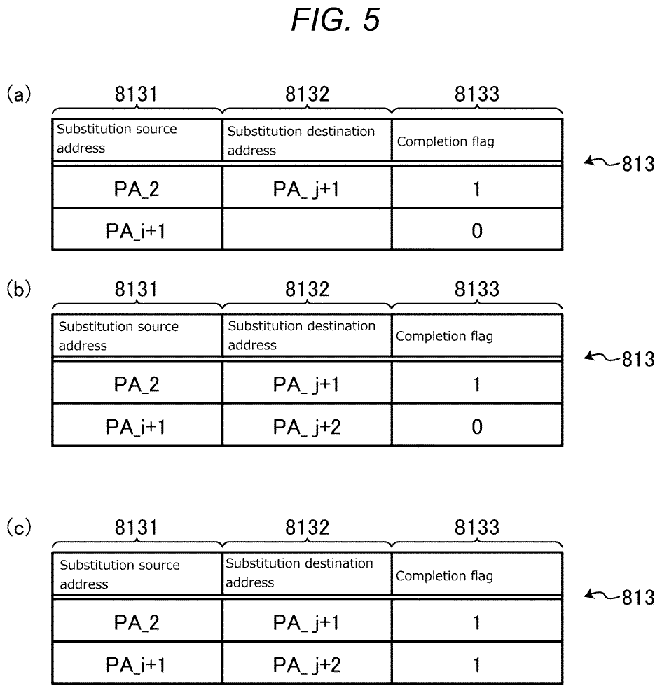

At this time, the controller 90 instructs the non-volatile memory 80 to update the address substitution information 813 and store the address substitution information 813 in the substitution management area 811d. For example, the controller 90 may update the address substitution information 813 on the volatile memory 70 as illustrated in FIG. 5. FIG. 5 is a diagram showing the updating of the address substitution information 813.

When receiving the correctable error notification signal of the data Di+1 in the FW area 811a, the controller 90 records the physical address PA_i+1 of the data Di+1 in the substitution source address field 8131 and records 0 in the corresponding completion flag field 8133 as shown in FIG. 5, part (a). In response to the correctable error notification signal, the controller 90 instructs the non-volatile memory 80 to store the data Di+1″ in the substitution area 811c. In response to this instruction, the control circuit 828 determines the storage destination of the data Di+1″ in the data register 823 to be the physical address PA_j+2 of the substitution area 811c. The control circuit 828 transfers the physical address PA_j+2 to the data register 823. The error correction circuit 83 notifies the controller 90 of the physical address PA_j+2 via the data register 843 and the input-output control circuit 841.

When the controller 90 receives the physical address PA_j+2, the controller 90 records the physical address PA_j+2 of the data D2 in the substitution destination address field 8132 corresponding to the substitution source address “PA_i+1” as shown in FIG. 5, part (b).

In the non-volatile memory 80, the sense amplifier 822 receives the notification of the physical address PA_j+2 from the control circuit 828. In response to this, the sense amplifier 822 stores the data Di+1″ in the data register 823 in the physical address PA_j+2 of the substitution area 811c, and stores the parity Pi+1″ in the data register 823 in the physical address PA_j+2′ of the redundant area 812. The physical address PA_j+2 and the physical address PA_j+2′ are associated with each other (for example, by being set as the same page address). The sense amplifier 822 transfers the substitution completion notification signal to the data register 823. The error correction circuit 83 supplies the substitution completion notification signal to the controller 90 via the data register 843 and the input-output control circuit 841.

When the controller 90 receives the substitution completion notification signal, as illustrated in FIG. 5, part (c), the controller 90 records 1 in the completion flag field 8133 corresponding to the substitution source address “PA_i+1” and the substitution destination address “PA_j+2”.

Thus, the data Di+1 in the parameter area 811b can be substituted with the data Di+1″ in the substitution area 811c. The control circuit 828 can access data Di+1″ of the physical address PA_j+2 instead of data Di+1 of the physical address PA_i+1 by referring to the address substitution information 813.

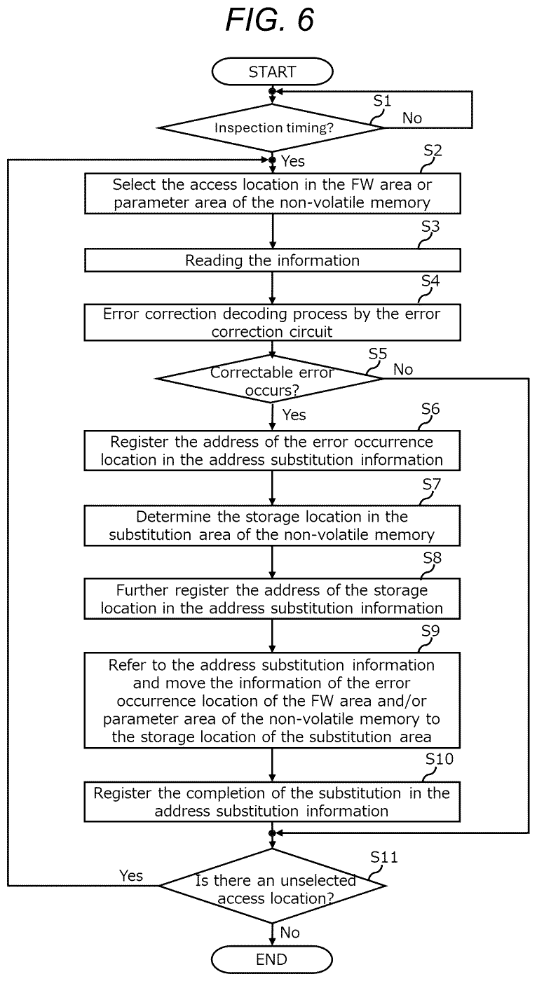

Next, the inspection process of the non-volatile memory 80 by the controller 90 will be described with reference to FIG. 6. FIG. 6 is a flowchart of the inspection process.

The controller 90 waits until the inspection time comes (No in S1). The inspection time may be at fixed interval or timing at which a predetermined period has elapsed from the previous inspection, a time at which the disk device 1 is started, a time at which management information related to the startup of the disk device 1 is acquired, or a time during an idle period of the disk device 1. The predetermined period for the inspection can be experimentally determined and then set in advance at a cycle deemed appropriate for performing inspections.

When the inspection time comes (Yes in S1), the controller 90 selects an access location in the FW area 811a and the parameter area 811b of the non-volatile memory 80 (S2). The controller 90 may select any unselected physical address from all the areas in the FW area 811a and the parameter area 811b as an access location. The controller 90 issues a read command including the selected physical address and supplies the read command to the non-volatile memory 80.

In response to the read command, the non-volatile memory 80 reads the stored information (S3) from the physical address selected in the S2 and reads the parity from the corresponding area of the redundant area 812. The non-volatile memory 80 performs error correction decoding processing (S4) on the read information by the error correction circuit 83 using the parity, and notifies the controller 90 of the result.

If no correctable error occurs in the error correction decoding process by the error correction circuit 83 (No in S5), the controller 90 advances the process to S11.

When a correctable error does occur in the error correction decoding process by the error correction circuit 83 (Yes in S5), the controller 90 registers the address of the error occurrence location in the address substitution information 813 (S6).

For example, when a correctable error occurs in data in the FW area 811a or the parameter area 811b in the error correction decoding process, the non-volatile memory 80 corrects the error in data using the parity and then generates the parity for the corrected data. The non-volatile memory 80 holds a code word including data and parity, and notifies the controller 90 of a correctable error.

If the reported correctable error is the first correctable error, the controller 90 may create address substitution information 813 on the volatile memory 70 and register the address of the error occurrence location in the address substitution information 813 as the substitution source address, as illustrated in FIG. 4, part (a).

Alternatively, if the reported correctable error is a second or subsequent correctable error after the first, the controller 90 may register the address of the error occurrence location in the address substitution information 813 as the substitution source address, and update the address substitution information 813, as illustrated in FIG. 5, part (a).

The controller 90 determines a storage location in the substitution area 811c of the non-volatile memory 80 (S7).

For example, if the unused physical address in the substitution area 811c is PA_j+1, the controller 90 determines the physical address of the substitution destination for the substitution source address registered in S5 to be PA_j+1.

Alternatively, if the unused physical address in the substitution area 811c is PA_j+2, the controller 90 determines the physical address of the t substitution destination for the substitution source address registered in S5 to be PA_j+2.

The controller 90 further registers the address of the storage location in the address substitution information 813 (S8).

For example, if the physical address of the storage location determined in S8 is PA_j+1, the controller 90 records the physical address PA_j+1 of the data D2″ in the substitution destination address field 8132 corresponding to the substitution source address “PA_1” as illustrated in FIG. 4, part (b).

Alternatively, if the physical address of the storage location determined in S8 is PA_j+2, the controller 90 records the physical address PA_j+2 of the data D2″ in the substitution destination address field 8132 corresponding to the substitution source address “PA_i+1” as illustrated in FIG. 5, part (b).

The controller 90 refers to the address substitution information 813, issues a move command to move the information of the error occurrence location of the FW area 811a and/or the parameter area 811b of the non-volatile memory 80 to the storage location of the substitution area 811c, and supplies the move command to the non-volatile memory 80 (S9).

For example, if the substitution source address “PA_1” and the substitution destination address “PA_j+1” are registered as substitution incomplete in the address substitution information 813 as illustrated in FIG. 4, part (b), the controller 90 issues a move command instructing the movement of data from the physical address “PA_1” to the physical address “PA_j+1” and supplies the move command to the non-volatile memory 80.

The non-volatile memory 80 reads the data of the physical address “PA_1” in response to the move command and writes the read data to the physical address “PA_j+1” of the substitution area 811c.

Alternatively, if the substitution source address “PA_i+1” and the substitution destination address “PA_j+2” are registered as substitution incomplete in the address substitution information 813 as illustrated in FIG. 5, part (b), the controller 90 issues a move command instructing the movement of data from the physical address “PA_i+1” to the physical address “PA_j+2” and supplies the move command to the non-volatile memory 80.

The non-volatile memory 80 reads the data of the physical address “PA_i+1” in response to the move command and writes the read data to the physical address “PA_j+2” of the substitution area 811c.

The controller 90 registers the completion of the substitution in the address substitution information 813 (S10).

For example, when the non-volatile memory 80 writes the data to the physical address “PA_j+1” of the substitution area 811c in response to the movement command, the non-volatile memory 80 notifies the controller 90 of the completion of the substitution. In response to this notification, the controller 90 records 1 in the completion flag field 8133 corresponding to the substitution source address “PA_1” and the substitution destination address “PA_j+1” as illustrated in FIG. 4, part (c).

Alternatively, when the non-volatile memory 80 writes the substitution area 811c to the physical address “PA_j+2” in response to the move command, the non-volatile memory 80 notifies the controller 90 of the completion of the substitution. In response to this notification, the controller 90 records 1 in the completion flag field 8133 corresponding to the substitution source address “PA_i+1” and the substitution destination address “PA_j+2” as illustrated in FIG. 5, part (c).

The controller 90 determines whether or not there is an unselected access location among the physical addresses of all the areas of the FW area 811a and the parameter area 811b (S11).

If there is an unselected physical address among the physical addresses of all the areas of the FW area 811a and the parameter area 811b, the controller 90 determines that there is an unselected access location (Yes in S11), and returns the process to S2.

If there is no unselected physical address among the physical addresses of all the areas of the FW area 811a and the parameter area 811b, the controller 90 determines that there is no unselected access location (No in S11), and ends the process.

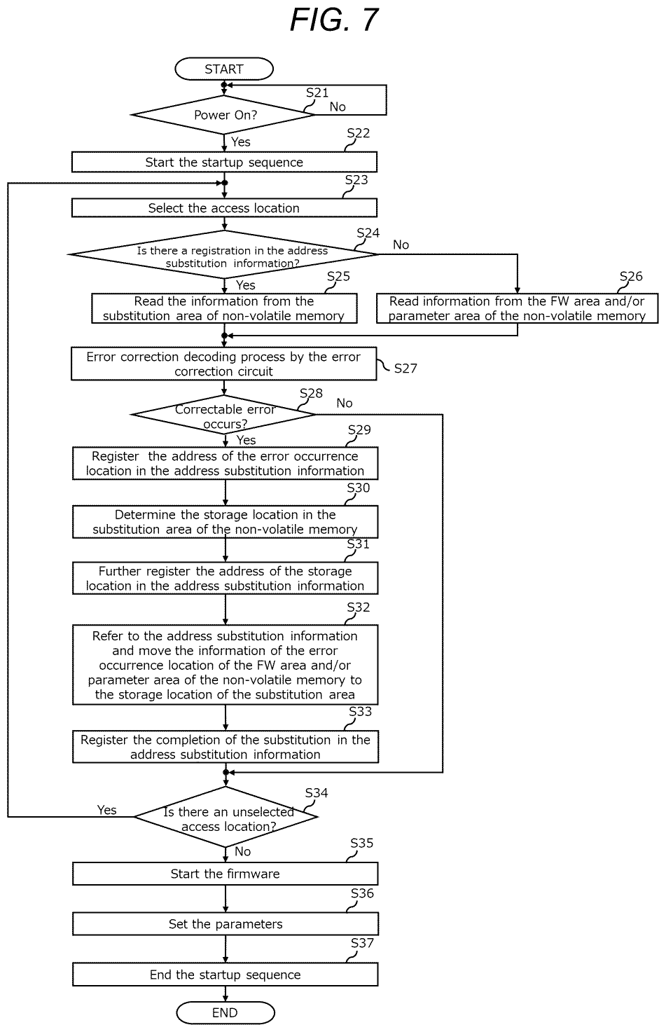

Next, the startup process of the disk device 1 by the controller 90 will be described with reference to FIG. 7. FIG. 7 is a flowchart of the startup process. FIG. 7 illustrates the startup process after the inspection process of FIG. 6 has been performed and the system has been shut down.

The controller 90 waits until the disk device 1 is powered on (No in S21). The controller 90 may determine that the disk device 1 is not yet powered on when the power supply voltage received from a power supply circuit in the disk device 1 is less than some threshold value. The controller 90 may determine that the disk device 1 has been powered on when the power supply voltage received from the power supply circuit in the disk device 1 is greater than or equal to a threshold value.

When the disk device 1 is powered on (Yes in S21), the controller 90 starts the startup sequence (S22), issues a startup command, and supplies the startup command to the non-volatile memory 70.

In response to the startup command, the non-volatile memory 70 reads the address substitution information 813 from the substitution management area 811d and returns the address substitution information 813 to the controller 90. The controller 90 stores the address substitution information 813 in the volatile memory 70.

The controller 90 selects an access location in the non-volatile memory 80 (S23). For example, the controller 90 may select, as an access location, an unselected physical address in an area (of all storage areas) in which information is stored in the FW area 811a and the parameter area 811b.

When the access location selected in S23 is registered in the address substitution information 813 (Yes in S24), the controller 90 specifies the storage location (substitution destination address) of the substitution area 811c corresponding to the selected access location in the address substitution information 813, issues a read command including the physical address of the storage location of the substitution area 811c, and supplies the read command to the non-volatile memory 80. The non-volatile memory 80 reads information from the physical address of the storage location of the substitution area 811c in response to the read command (S25).

The controller 90 temporarily stores the information read from the non-volatile memory 80 in S25 in the volatile memory 70.

If the access location selected in S23 is not registered in the address substitution information 813 (No in S24), the controller 90 issues a read command including the physical address of the access location selected in S23 and supplies the read command to the non-volatile memory 80. The non-volatile memory 80 reads information from the physical address of the access location selected in the S23 in response to the read command (S26).

The controller 90 temporarily stores the information read from the non-volatile memory 80 in S26 in the volatile memory 70.

For example, it may be assumed that the address substitution information 813 is in the state illustrated in FIG. 5, part (c).

When the selected access location is the physical address PA_1 (see FIG. 3), the controller 90 issues a read command including the physical address PA_1 and supplies the read command to the non-volatile memory 80 because the physical address PA_1 is not registered in the address substitution information 813. The non-volatile memory 80 reads information (e.g., a part of the firmware) from the physical address PA_1 of the FW area 811a in response to the read command.

When the selected access location is the physical address PA_2, the controller 90 specifies that the physical address PA_2 is registered in the address substitution information 813 and the substitution destination is the physical address PA_j+1. The controller 90 issues a read command including the specified physical address PA_j+1 and supplies the read command to the non-volatile memory 80. The non-volatile memory 80 reads information (e.g., a part of the firmware) from the physical address PA_j+1 of the substitution area 811c in response to the read command.

When the selected access location is the physical address PA_i, the controller 90 issues a read command including the physical address PA_i and supplies the read command to the non-volatile memory 80 because the physical address PA_i is not registered in the address substitution information 813. The non-volatile memory 80 reads information (e.g., a part of firmware) from the physical address PA_i of the FW area 811a in response to the read command.

When the selected access location is the physical address PA_i+1, the controller 90 specifies that the physical address PA_i+1 is registered in the address substitution information 813 and the substitution destination is the physical address PA_j+2. The controller 90 issues a read command including the specified physical address PA_j+2 and supplies the read command to the non-volatile memory 80. The non-volatile memory 80 reads information (e.g., parameters) from the physical address PA_j+2 of the substitution area 811c in response to the read command.

When the selected access location is the physical address PA_i+2, the controller 90 issues a read command including the physical address PA_i+2 and supplies the read command to the non-volatile memory 80 because the physical address PA_i+2 is not registered in the address substitution information 813. The non-volatile memory 80 reads information (e.g., parameters) from the physical address PA_i+2 of the parameter area 811b in response to the read command.

When the selected access location is the physical address PA_j, the controller 90 issues a read command including the physical address PA_j and supplies the read command to the non-volatile memory 80 because the physical address PA_j is not registered in the address substitution information 813. The non-volatile memory 80 reads information (e.g., parameters) from the physical address PA_j of the parameter area 811b in response to the read command.

The non-volatile memory 80 performs error correction decoding processing on the read information by the error correction circuit 83 using the parity (S27), and notifies the controller 90 of the result.

When a correctable error occurs in the error correction decoding process by the error correction circuit 83 (Yes in S28), the controller 90 registers the address of the error occurrence location in the address substitution information 813 (S29).

For example, when a correctable error occurs in data in the FW area 811a or the parameter area 811b in the error correction decoding process by the error correction circuit 83, the non-volatile memory 80 corrects the error in data using the parity and generates the parity for the corrected data. The non-volatile memory 80 holds a code word including data and parity, and notifies the controller 90 of a correctable error.

The controller 90 determines a storage location in the substitution area 811c of the non-volatile memory 80 (S30).

The controller 90 further registers the address of the storage location in the address substitution information 813 (S31).

The controller 90 refers to the address substitution information 813, issues a move command to move the information of the error occurrence location of the FW area 811a and/or the parameter area 811b of the non-volatile memory 80 to the storage location of the substitution area 811c, and supplies the move command to the non-volatile memory 80 (S32).

The non-volatile memory 80 reads the data of the physical address of the substitution source in response to the move command and writes the read data to the physical address of the substitution area 811c.

The controller 90 registers the completion of the substitution in the address substitution information 813 (S33).

The controller 90 determines whether or not there is an unselected access location among the physical addresses of all the storage areas of the FW area 811a and the parameter area 811b (S34).

If there is an unselected physical address among the physical addresses of all the storage areas of the FW area 811a and the parameter area 811b, the controller 90 determines that there is still an unselected access location (Yes in S34), and returns the process to S23.

If there is no unselected physical address remaining among the physical addresses of all the storage areas of the FW area 811a and the parameter area 811b, the controller 90 determines that there is no unselected access location left (No in S34), starts the firmware using the information temporarily stored in the volatile memory 70 (S35), and sets the parameter(s) in the firmware (S36). After this, the controller 90 ends the startup sequence (S37).

As described above, in the embodiment, in the disk device 1, the controller 90 stores information of an error correction unit including a bit that becomes a correctable error among a plurality of error correction units included in the FW area 811a and the parameter area 811b in the substitution area 811c instead of the FW area 811a and the parameter area 811b. The controller 90 creates or updates the address substitution information 813 and stores the address substitution information 813 in the substitution management area 811d. In the address substitution information 813, the address of the error correction unit of the correctable error and the address of the error correction unit in the substitution area 811c are associated with each other. Thus, since the information of an error correction unit including a bit that becomes a correctable error can be stored and managed in the storage location of the substitution area 811c instead of the FW area 811a and the parameter area 811b before the error correction unit of the correctable error becomes the uncorrectable error, the read error of the FW/parameter or the like can be reduced, and the startup failure of the disk device 1 can be avoided.

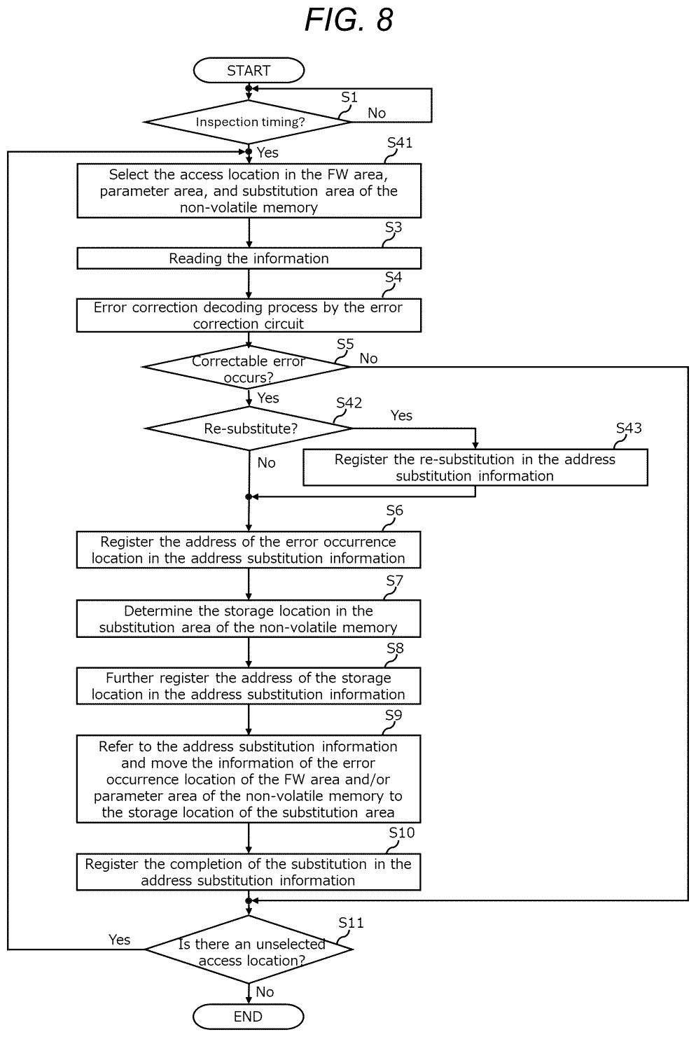

As a modification of the embodiment, the inspection process of the non-volatile memory 80 may be performed on the substitution area 811c in addition to the FW area 811a and the parameter area 811b as illustrated in FIG. 8. FIG. 8 is a flowchart of the inspection process in the modification of the embodiment.

The controller 90 waits until the inspection time comes (No in S1), and when the inspection time comes (Yes in S1), the controller 90 selects an access location in the FW area 811a, the parameter area 811b, and the substitution area 811c of the non-volatile memory 80 (S41). The controller 90 may select, as an access location, an unselected physical address from all the areas the FW area 811a, the parameter area 811b, and the substitution area 811c. The controller 90 issues a read command including the selected physical address and supplies the read command to the non-volatile memory 80.

Thereafter, S3 and S4 are performed in the same manner as already described above.

If no correctable error occurs in the error correction decoding process by the error correction circuit 83 (No in S5), the controller 90 advances the process to S11.

If a correctable error does occur in the error correction decoding process by the error correction circuit 83 (Yes in S5), the controller 90 then determines whether to perform re-substitution (S42).

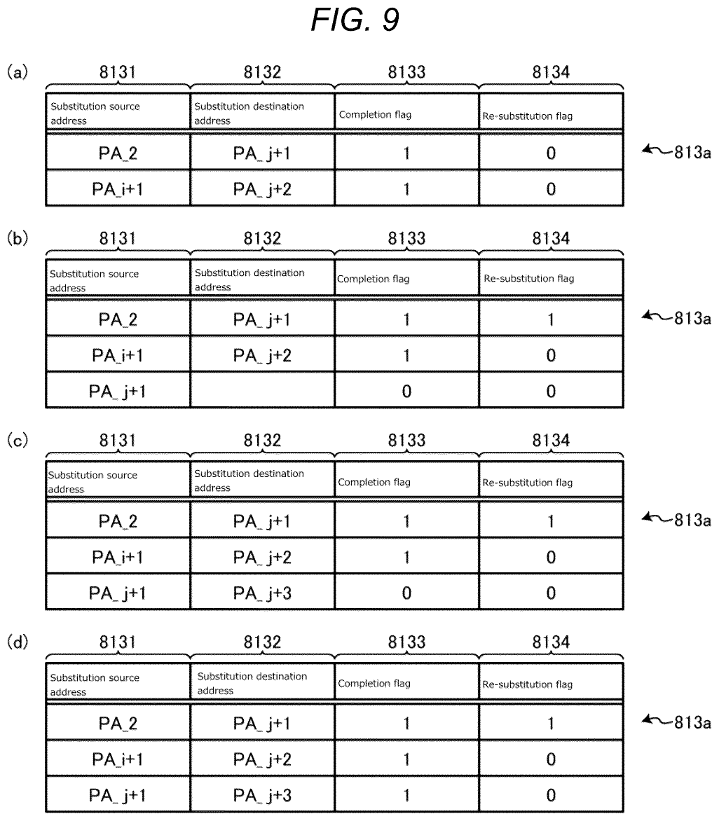

For example, if the correctable error has occurred in information that has already been substituted in the substitution area 811c, the information should be re-substituted in another storage location in the substitution area 811c. In consideration of this, as illustrated in FIG. 9, the address substitution information 813a is further associated with a re-substitution flag in addition to the physical address of the substitution source, the physical address of the substitution destination, and the completion flag. FIG. 9 is a diagram showing the configuration and updating of the address substitution information 813 in the modification of the embodiment.

The address substitution information 813a further includes a re-substitution flag field 8134. The re-substitution flag field 8134 records the presence or absence of re-substitution. In the re-substitution flag field 8134, “0” indicating that there is no re-substitution or “1” indicating that there is re-substitution may be recorded.

If the reported location of the correctable error is registered as the substitution destination address in the address substitution information 813a, the controller 90 determines that the correctable error should be re-substituted (Yes in S42), registers the re-substitution in the address substitution information 813a (S43), and registers the address of the error occurrence location in the address substitution information 813a (S6).

For example, if the reported location of the correctable error is the physical address PA_j+1, the controller 90 recognizes that the physical address PA_j+1 is registered as the substitution destination address as illustrated in FIG. 9, part (a). In response to this, the controller 90 records “1” in the re-substitution flag field 8134 corresponding to the substitution destination address “PA_j+1” as illustrated in FIG. 9, part (b). At the same time, the controller 90 additionally registers the substitution source address “PA_j+1”, and records “0” in the corresponding completion flag field 8133 and re-substitution flag field 8134.

If the reported location of the correctable error is not registered as the substitution destination address in the address substitution information 813a, the controller 90 determines that the correctable error should not be re-substituted (No in S42), and registers the address of the error occurrence location in the address substitution information 813a without registering the re-substitution (S6).

Thereafter, S7 to S11 are performed in the same manner as already described above.

For example, if the physical address of the storage location determined in the S8 is PA_j+3, the controller 90 records the physical address PA_j+3 in the substitution destination address field 8132 corresponding to the substitution source address “PA_j+1” as illustrated in FIG. 9, part (c).

For example, in S9, when the non-volatile memory 80 writes the data to the physical address “PA_j+3” of the substitution area 811c in response to the movement command, the non-volatile memory 80 notifies the completion of the substitution to the controller 90. In response to this notification, the controller 90 records “1” in the completion flag field 8133 corresponding to the substitution source address “PA_j+1” and the substitution destination address “PA_j+3” as illustrated in FIG. 9, part (d).

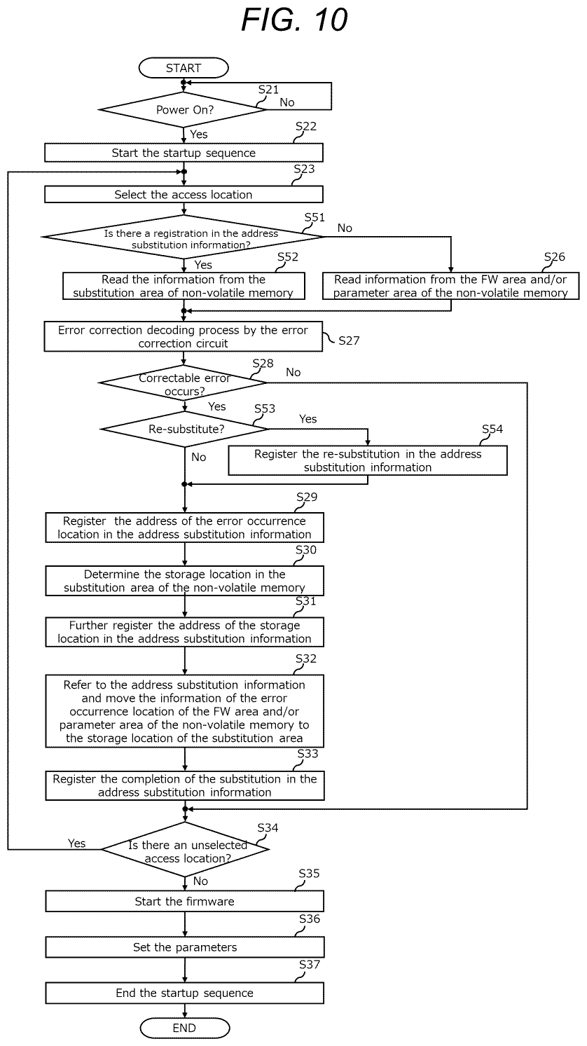

In addition, as illustrated in FIG. 10, the startup process different from the embodiment may be performed in the following points in accordance with the change of the inspection process. FIG. 10 is a flowchart illustrating the startup process according to the modification of the embodiment. FIG. 10 illustrates the startup process after the inspection process of FIG. 8 is performed and the shutdown is performed.

S21 to S23 are performed in the same manner as already described above.

If the access location selected in S23 is registered in the address substitution information 813a (Yes in S51), the controller 90 specifies the storage location (substitution destination address) of the substitution area 811c corresponding to the selected access location in the address substitution information 813a, and checks whether or not the access location is re-substituted. The controller 90 checks the re-substitution flag field 8134 corresponding to the substitution destination address, and determines that the substitution destination address is not re-substituted if the re-substitution flag is “0”, and determines that the substitution destination address is re-substituted if the re-substitution flag is “1”.

If the substitution destination address is not re-substituted, the controller 90 issues a read command including the physical address of the substitution destination and supplies the read command to the non-volatile memory 80.

If the substitution destination address is re-substituted, the controller 90 checks whether the substitution destination address is in the substitution source address in the address substitution information 813a, and if the substitution destination address is in the substitution source address, the controller 90 specifies the storage location (substitution destination address) of the substitution area 811c corresponding to the substitution source address, issues a read command including the physical address of the re-substitution destination, and supplies the read command to the non-volatile memory 80.

The non-volatile memory 80 reads information from the physical address of the storage location of the substitution area 811c in response to the read command (S52).

The controller 90 temporarily stores the information read from the non-volatile memory 80 in S52 in the volatile memory 70.

If the access location selected in S23 is not registered in the address substitution information 813a (No in S51), the controller 90 issues a read command including the physical address of the access location selected in S23 and supplies the read command to the non-volatile memory 80. The non-volatile memory 80 reads information from the physical address of the access location selected in S23 in response to the read command (S26).

The controller 90 temporarily stores the information read from the non-volatile memory 80 in S26 in the volatile memory 70.

For example, it may be assumed that the address substitution information 813 is in the state illustrated in FIG. 9, part (d).

When the selected access location is the physical address PA_2, the controller 90 specifies that the physical address PA_2 is registered in the address substitution information 813a and the substitution destination is the physical address PA_j+1. The controller 90 checks whether the physical address is re-substituted. The controller 90 checks that the re-substitution flag corresponding to the substitution destination address “PA_j+1” is “1” and the physical address is re-substituted. The controller 90 confirms that “PA_j+1” is in the substitution source address field 8131, and specifies that the substitution destination address corresponding to the substitution source address “PA_j+1” is “PA_j+3”. The controller 90 issues a read command including the physical address “PA_j+3” and supplies the read command to the non-volatile memory 80. The non-volatile memory 80 reads information (e.g., a part of firmware) from the physical address PA_j+3 of the substitution area 811c in response to the read command.

Thereafter, S27 is performed in the same manner as described for an embodiment above.

If no correctable error occurs in the error correction decoding process by the error correction circuit 83 (No in S28), the controller 90 advances the process to S34.

If a correctable error does occur in the error correction decoding process by the error correction circuit 83 (Yes in S28), the controller 90 then determines whether or not to perform re-substitution (S53).

If the reported location of the correctable error is registered as a substitution destination address in the address substitution information 813a, the controller 90 determines that the reported location of the correctable error should be re-substituted (Yes in S53), registers the re-substitution in the address substitution information 813a (S54), and registers the address of the error occurrence location in the address substitution information 813a (S29).

If the reported location of the correctable error is not registered as a substitution destination address in the address substitution information 813a, the controller 90 determines that the reported location of the correctable error should not be re-substituted (No in S53), and registers the address of the error occurrence location in the address substitution information 813a without registering the re-substitution (S29).

Thereafter, S30 to S37 are performed in the same manner as already described above.

In the disk device 1, the controller 90 can substitute and store the correctable error in the storage location of the substitution area 811c as a substitute and manage the correctable error before the error correction unit of the correctable error becomes the uncorrectable error, and thus, it is possible to reduce the read error of the FW/parameter and the like and to avoid the startup failure of the disk device 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. These embodiments and modifications thereof are included in the scope and spirit of the invention, and are included in the invention described in the claims and the scope of equivalents thereof.

What is claimed is:

1. A disk device, comprising:
a non-volatile memory; and
a controller that is capable of accessing the non-volatile memory, wherein
the non-volatile memory includes an error correction circuit and a storage area, and
the storage area includes a first area, a second area, and a third area,
the first area comprises a plurality of error correction units, and
the controller is configured to store information from a first error correction unit in the plurality of error correction units in the second area when the first error correction unit includes a bit that that is a correctable error for the error correction processing by the error correction circuit, then create or update address substitution information in which an address of the first error correction unit in the first area is associated with an address at which the information from the first error correction unit was stored in the second area, and store the address substitution information in the third area.

2. The disk device according to claim 1, wherein the controller is configured to perform an inspection process including:
perform the error correction process using the error correction circuit on information read from each of the plurality of error correction units, and
determine whether there is any error correction unit that has a correctable error in the first area.

3. The disk device according to claim 1, wherein management information related to startup is stored in the first area.

4. The disk device according to claim 3, wherein the controller is configured to:
perform an inspection process on the first area including the error correction processing using the error correction circuit on the information read from each of the plurality of error correction units to determine whether there is any error correction unit that has a correctable error.

5. The disk device according to claim 4, wherein the controller is configured to perform the inspection process when a predetermined period elapses after a previous inspection process on the first area.

6. The disk device according to claim 4, wherein the controller is configured to perform the inspection process at start up.

7. The disk device according to claim 4, wherein the controller is configured to perform the inspection process when the management information is initially acquired.

8. The disk device according to claim 4, wherein the controller is configured to perform the inspection process during an idle state.

9. The disk device according to claim 1, wherein
the non-volatile memory further includes a redundant area, and
the error correction circuit stores parity for information stored in the storage area in the redundant area.

10. The disk device according to claim 1, further comprising:
a head disk assembly; and
a disk medium to which information can be written to and read from by the head disk assembly.

11. A storage device, comprising:
a disk medium;
a non-volatile memory; and
a controller that is capable of accessing the non-volatile memory and the disk medium, wherein
the non-volatile memory includes an error correction circuit and a storage area, and
the storage area includes a first area, a second area, and a third area,
the first area comprises a plurality of error correction units, and
the controller is configured to store information from a first error correction unit in the plurality of error correction units in the second area when the first error correction unit includes a bit that that is a correctable error for the error correction processing by the error correction circuit, then create or update address substitution information in which an address of the first error correction unit in the first area is associated with an address at which the information from the first error correction unit was stored in the second area, and store the address substitution information in the third area.

12. The storage device according to claim 11, wherein the controller is configured to perform an inspection process including:
perform the error correction process using the error correction circuit on information read from each of the plurality of error correction units, and
determine whether there is any error correction unit that has a correctable error in the first area.

13. The storage device according to claim 11, wherein management information related to startup is stored in the first area.

14. The storage device according to claim 13, wherein the controller is configured to:
perform an inspection process on the first area including the error correction processing using the error correction circuit on the information read from each of the plurality of error correction units to determine whether there is any error correction unit that has a correctable error.

15. The storage device according to claim 14, wherein the controller is configured to perform the inspection process when a predetermined period elapses after a previous inspection process on the first area.

16. The storage device according to claim 14, wherein the controller is configured to perform the inspection process at start up.

17. The storage device according to claim 14, wherein the controller is configured to perform the inspection process when the management information is initially acquired.

18. The storage device according to claim 14, wherein the controller is configured to perform the inspection process during an idle state.

19. The storage device according to claim 11, wherein
the non-volatile memory further includes a redundant area, and
the error correction circuit stores parity for information stored in the storage area in the redundant area.

20. The storage device according to claim 11, wherein the controller comprises a processor and a hard disk controller.
